(19) United States
(12) Patent Application Publication
(10) Pub. No.: US 2014/0297318 A1
(43) Pub. Date: Oct. 2, 2014

(54) SYSTEMS AND METHODS FOR AUTOMATICALLY SCHEDULING PATIENT VISITS BASED ON INFORMATION IN CLINICAL NOTES OF ELECTRONIC MEDICAL RECORDS

(71) Applicant: MCKESSON SPECIALTY CARE DISTRIBUTION CORPORATION, (US)

(72) Inventors: Anita Kumari Prasad, Fremont, CA (US); Rakesh Wagh, Foster City, CA (US); Calvin A. Chock, Milpitas, CA (US)

(73) Assignee: MCKESSON SPECIALTY CARE DISTRIBUTION CORPORATION, San Francisco, CA (US)

(21) Appl. No.: 13/852,370

(22) Filed: Mar. 28, 2013

(51) Int. Cl. G06Q 50/24; G06Q 10/10

(52) U.S. Cl. CPC G06Q 50/24; G06Q 10/1095
USPC 705/3

(57) ABSTRACT

Systems and methods are provided for automatically scheduling patient visits based on information in electronic medical records (EMRs). In one exemplary embodiment, a computer-implemented method for scheduling patient visits based on information in EMRs may be provided and performed by one or more computers associated with a service provider. An EMR for a patient can be evaluated to determine if it contains information indicating a need to schedule a future vising for the patient. Multiple scheduling parameters can be identified in the EMR. A schedule for a healthcare provider can be received, for example by the service provider computer. The schedule of the healthcare provider can be evaluated based on one or more of the identified scheduling parameters. In addition, a suggested appointment time for the future visit for the patient can be identified based at least in part on the evaluation of the schedule.

### TECHNICAL FIELD

Aspects of the disclosure relate generally to patient healthcare scheduling, and more particularly, to systems and methods for automatically scheduling patient visits based on information in clinical notes of electronic medical records.

### BACKGROUND

A patient may visit many different types of healthcare providers, such as a doctor, hospital, nurse, nurse practitioner, physical therapist, laboratory, etc., as part of the patient's overall healthcare regimen. In many situations, after a patient completes a visit to a particular healthcare provider, the patient will need to return to the healthcare provider at some point for another visit. The reasons for the return visit are numerous and include, but are not limited to, a routine check-up, conducting new testing on the patient, conducting additional testing on the patient (to determine if changes have occurred), ongoing rehabilitation, evaluate recovery from or progression of a condition, and receive ongoing procedures (chemotherapy, radiation, etc.).

However, scheduling follow-up appointments for a patient is a task that is generally manually-oriented and disconnected from a healthcare provider's workflow. The healthcare provider will typically generate notes based on the current patient visit and may include in those notes information regarding a need for follow-up visits and when, generally, those follow-up visits should occur. An assistant or “scheduler” reads the notes and determines if and when the healthcare provider wants to schedule a subsequent visit by the patient. Based on that determination, the scheduler goes into the computer system to view the healthcare provider's schedule to determine a time, based on the general time for a follow-up visit and the time needed for the follow-up visit, when the healthcare provider is available to conduct the follow-up visit and then schedules the follow-up visit with the patient. Much of this could be automated to reduce the amount of time needed to schedule the follow-up visit and free up personnel for other duties within the office of the healthcare provider.

### SUMMARY

Exemplary embodiments disclosed herein may include systems and methods for automatically scheduling patient visits based on information in electronic medical records (EMRs). In one exemplary embodiment, a computer-implemented method for scheduling patient visits based on information in EMRs may be provided and performed by one or more computers associated with a service provider. An EMR for a patient may be evaluated to determine if it contains information indicating a need to schedule a future vising for the patient. Multiple scheduling parameters can be identified in the EMR. A schedule for a healthcare provider can be received, for example by the service provider computer. The schedule of the healthcare provider can be evaluated based on one or more of the identified scheduling parameters. In addition, a suggested appointment time for the future visit for the patient can be identified based at least in part on the evaluation of the schedule.

In accordance with another embodiment, a system for automatically scheduling patient visits based on information in EMRs may be provided. The system may include at least one memory operable to store computer-executable instructions. The system may also include at least one processor configured to access the at least one memory and execute the computer-executable instructions. The processor may be configured to evaluate an EMR for a patient to determine if it contains information indicating a need to schedule a future visit with the patient. The processor may be further configured to identify multiple schedule parameters in the EMR. The processor may be further configured to receive a schedule for a healthcare provider and evaluate the schedule based on one or more of the scheduling parameters. The processor may be further configured to identify a suggested appointment time for the future visit for the patient based at least in part on the evaluation of the schedule.

### BRIEF DESCRIPTION OF THE DRAWINGS

Reference will now be made to the accompanying drawings, which are not necessarily drawn to scale, and wherein:

FIG. 1 illustrates an example overview of a system that facilitates automatically scheduling patient visits based on information in clinical notes of electronic medical records according to one exemplary embodiment.

FIGS. 2A-B are a flow chart of an example method for automatically scheduling patient visits based on information in clinical notes of electronic medical records according to one exemplary embodiment.

FIG. 3 is a flow chart of an example method for determining a suggested appointment time for a patient visit according to one exemplary embodiment.

FIG. 4 is a depiction of an example clinical notes page of an electronic medical record that may be displayed according to one exemplary embodiment.

FIG. 5 is a depiction of an example scheduling order form in the clinical notes for scheduling a patient visit that may be displayed according to one exemplary embodiment.

FIG. 6 is a depiction of an example appointment scheduling page that may be displayed according to one exemplary embodiment.

### DETAILED DESCRIPTION OF EXEMPLARY EMBODIMENTS

Exemplary embodiments will now be described more fully hereinafter with reference to the accompanying drawings, in which exemplary embodiments are shown. The concepts disclosed herein may, however, be embodied in many different forms and should not be construed as limited to the exemplary embodiments set forth herein; rather, these embodiments are provided so that this disclosure will be thorough and complete, and will fully convey the scope of the concepts to those skilled in the art. Like numbers refer to like, but not necessarily the same or identical, elements throughout.

Exemplary embodiments described herein include systems and methods that facilitate the automatic scheduling of patent visits based on information contained in clinical notes of electronic medical records. For example, a doctor or other healthcare provider may fill out notes (either by dictation or typing them in) in a clinical notes page of an electronic medical record for a patient. The information in the clinical notes page can be parsed to identify key terms associated with the scheduling of another visit by the patient. The key terms can be evaluated to determine a date in the future, duration, and person or “resource” to be available at the next visit of the patient. The schedule of the resource can be evaluated around the date in the future based on the anticipated duration of the next visit to find a period in the resource's schedule that can accommodate the visit. The next visit of the patient can then be scheduled based on the determined availability in the schedule of the resource.

System Overview

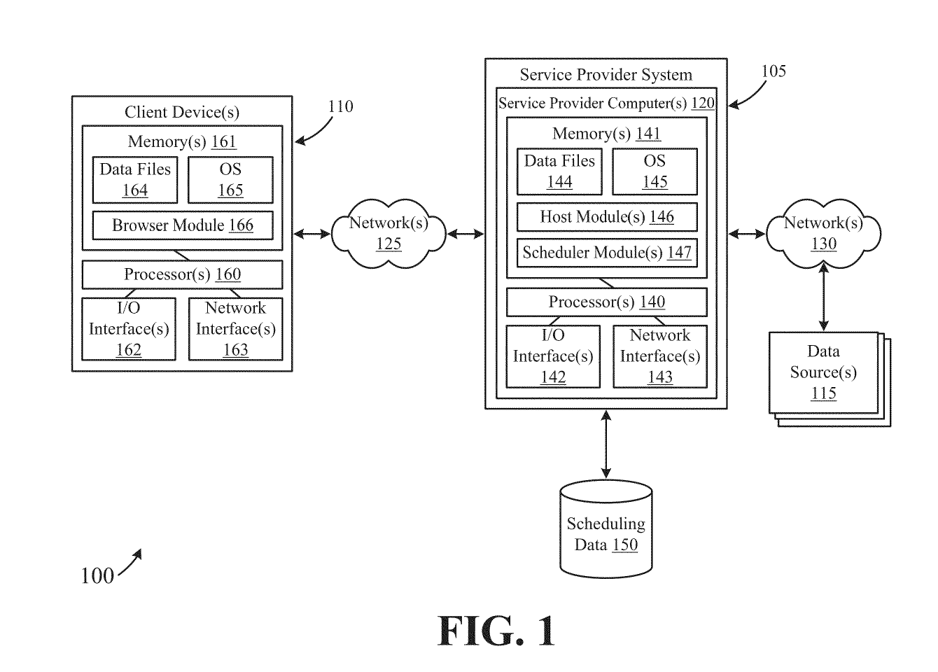

An example system 100 that facilitates the automatic scheduling of patient visits based on information in clinical notes of electronic medical records will now be described illustratively with respect to FIG. 1. As shown in FIG. 1, the system 100 may include at least one service provider system 105 and one or more client devices 110. In certain exemplary embodiments, the system 100 may additionally include one or more data sources 115. Additionally, the service provider system 105 may include any number of suitable service provider computers 120. In operation, the service provider computers 120 may respond to requests received from the client devices 110 associated with the presentation of electronic medical records (EMRs) and patient scheduling services. Additionally, as desired, each of the service provider computers 120, the client devices 110, and/or the data sources 115 may include one or more processing devices that may be configured for accessing and reading associated computer-readable media having data stored thereon and/or computer-executable instructions for implementing the various methods of the embodiments.

Generally, network devices and systems, including one or more of the service provider computers 120, the client devices 110, and/or the data sources 115 may include or otherwise be associated with suitable hardware and/or software for transmitting and receiving data, signals, and/or computer-executable instructions over one or more communications links or networks. As desired, these network devices and systems may also include any number of processors for processing data and executing computer-executable instructions, as well as other internal and peripheral components that are well-known in the art. Further, these network devices and systems may include or be in communication with any number of suitable memory devices operable to store data and/or computer-executable instructions. By executing computer-executable instructions, each of the network devices may form a special purpose computer or particular machine. As used herein, the term “computer-readable medium” describes any form of suitable memory or memory device.

As shown in FIG. 1, the service provider computers 120, the client devices 110, and/or the data sources 115 may be in communication with each other via one or more networks, such as networks 125, 130, which as described below can include one or more separate or shared private and public networks, including the Internet and/or a publicly switched telephone network. In certain embodiments, the illustrated networks 125, 130 may be the same network. In other embodiments, separate networks may be utilized to facilitate communication between various components of the system 100. Each of these components—the service provider computers 120, the client devices 110, the data sources 115, and the networks 125, 130—will now be discussed in further detail.

The service provider system 105 may be associated with any suitable service provider or other entity that facilitates the management of patient scheduling services, either in cooperation with or separate from EMRs. Examples of suitable service providers include, but are not limited to, service providers that collect medical information via the routing of healthcare transactions (e.g., eligibility transactions, healthcare claim transactions, etc.) and/or service providers that act as central repositories for medical information (e.g., governmental entities, third-party service providers, systems associated with healthcare providers, etc.). As set forth above, the service provider system 105 may include any number of service provider computers 120. Each service provider computer 120 may include, but is not limited to, any suitable processor-driven device configured for receiving, processing, and fulfilling requests from the client devices 110 relating to patient scheduling services, either in cooperation with or separate from EMRs. Additionally, in certain embodiments, a service provider computer 120 may be configured to obtain or collect medical information from the one or more data sources 115. In certain exemplary embodiments, the service provider computer 120 may include a suitable host server (e.g., a Web server, a server that integrates with dedicated applications on client devices 110,), a host module, or other software that facilitates the receipt and processing of patient scheduling services. Any number of client devices 110 and/or data sources 115 may be in communication with the service provider computer 120 as desired in various exemplary embodiments.

The service provider computer 120 may include any number of special purpose computers or other particular machines, application-specific circuits, microcontrollers, personal computers, minicomputers, mainframe computers, servers, networked computers, and/or other processor-driven devices. In certain exemplary embodiments, the operations of the service provider computer 120 may be controlled by computer-executed or computer-implemented instructions that are executed by one or more processors 140 associated with the service provider computer 120 to form a special purpose computer or other particular machine operable to facilitate receiving and/or processing patient scheduling services. The one or more processors 140 that control the operations of the service provider computer 120 may be incorporated into the service provider computer 120 and/or in communication with the service provider computer 120 via one or more suitable networks. In certain exemplary embodiments, the operations and/or control of the service provider computer 120 may be distributed among several processing components.

In addition to one or more processors 140, the service provider computer 120 may include one or more memory devices 141, one or more input/output (“I/O”) interfaces 142, and/or one or more network interfaces 143. The one or more memory devices 141 may be any suitable memory devices, for example, caches, read-only memory devices, random access memory devices, magnetic storage devices, removable memory devices, etc. The one or more memory devices 141 may store data, executable instructions, and/or various program modules utilized by the service provider computer 120, for example, data files 144, an operating system (“OS”) 145, one or more host modules 146, and/or one or more scheduler modules 147. Additionally, in certain example embodiments, one or more scheduling data databases 150 may be provided. The scheduling data databases 150 may include any number of internal and/or external databases accessible by the service provider computer 120. As desired, the service provider computer 120 may include a suitable database management system configured to manage the data stored in the scheduling data databases 150.

The data files 144 may store any suitable data that facilitates the operations of the service provider computer 120. Examples of suitable data that may be stored in the data files 144 include, but are not limited to, identification information for one or more client devices 110, information that facilitates communication with the client devices 110, information that facilitates communication with the data sources 115, EMR data received from the data sources 115, scheduling data received from the database 150, information that facilitates the generation of one or more displays associated with EMRs, information that facilitates the population of data elements within an EMR, information that facilitates the patient scheduling services, and/or information associated with received requests for patient scheduling services.

The scheduling data databases 150 may include any number of suitable databases configured to store data associated with patient scheduling services and/or EMRs. Examples of information within the scheduling data database 150 include, but are not limited to, schedules, tables and/or listings of terms and/or phrases related to the scheduling of patient visits. Additional information may be associated with each term or phrase, such as plural or singular versions of the terms and/or phrase, synonyms for the terms and/or phrases, variations based on typical typographical errors or grammatical errors of one or more terms and/or phrases, the scheduling category associated with each term and/or phrase, time duration (if any) associated a term and/or phrase (e.g., for terms/phrases associated with a service to be provided to the patient), and any other information desired for term and/or phrase matching for scheduling of patient visits. In addition, the scheduling data database 150 can include tables, schedules, and/or listings of potential resources, location types, locations, resource types, procedures, time durations associated with each procedure, work schedules, and calendars or schedules for each resource. In addition, the database 150 can include information for generating and presenting EMRs, clinical note pages of EMRs, scheduling order pages of EMRs and other user interfaces associated with the EMR. In addition, the database 150 can include a wide variety of EMR data, such as patient identification information, information associated with medical and/or medication history of a patient, information associated with a current medical status of a patient, and/or information associated with future or planned treatments and/or medication therapy. In certain embodiments, information stored in the scheduling data databases 150 may include information collected by the service provider system 105 and/or service provider computers 120. In addition, in certain embodiments, at least a portion of the information received from the data sources 115 may be stored in the databases 150.

The OS 145 may be a suitable software module that controls the general operation of the service provider computer 120 and/or that facilitates the execution of other software modules. The OS 145 may be, but is not limited to, Microsoft Windows®, Apple OSX™, Linux, Unix, or a mainframe operating system. The host modules 146 may include any number of suitable modules and/or applications that facilitate communications with the client devices 110. For example, the host modules 146 may include one or more suitable web server applications and/or server applications configured to communicate with one or more applications (including dedicated applications) executed by the client devices 110. In operation, a host module 146 may receive, process, and/or respond to requests from the client devices 110, such as requests for patient scheduling services. As desired, in certain exemplary embodiments, the host modules 146 may additionally facilitate communications with the data sources 115. In this regard, a wide variety of EMR and/or healthcare information may be collected from the data sources 115.

The scheduler modules 147 may include any number of suitable modules and/or applications configured to receive and process requests for patient scheduling services for any number of patients. In operation, a scheduler module 147 may receive information that has been provided in clinical notes or another portion of an EMR (e.g., patient evaluation notes that have been typed in or dictated into the clinical notes section of an EMR). The scheduler module 147 may scan the received information based terms or phrases in the database 150 to determine if a generally when a healthcare provider (e.g., a doctor, nurse practitioner, nurse, hospital, physical therapist, etc.) would like to schedule another visit by the patient being evaluated. The scheduler module 147 can determine based on identified terms and phrases through a matching process the general date in the future (e.g., a date specific, a listing of a number of days, weeks or months, in the future for the visit, etc.) for scheduling the next visit, the estimated time duration of the next visit, the resource who will need to be available during that next visit, and the location for the next visit. The scheduler module 147 may then retrieve the calendar or schedule for the identified resource from the database 150, the data files 144 of the service provider computer, the data files 164 of the client device 110, or the data source 115 and can determine an opening in the resource's schedule based on the general date in the future and the estimated time duration of the next visit. The scheduler module may then select an available time and present it as a suggested appointment time. In certain embodiments, the scheduler module 147 may also receive verification from the resource, an assistant handling the scheduling for a resource, and/or the patient that the suggested appointment time is satisfactory before permanently adding the appointment to the schedule of the resource. In addition, a wide variety of additional services related to scheduling may be provided by the scheduler module 147 as part of the patient scheduling services.

Once the scheduler module 147 has determine a suggested appointment time, the module 147 may retrieve and determine how to display the suggested appointment time within the calendar or schedule for the resource in a manner suitable for review on the client device 110 associated with the resource or the assistant for the resource and/or the client device associated with the patient. A wide variety of suitable methods and/or techniques may be utilized as desired to determine a displayable portion and to populate the displayable portion of the calendar or schedule by the scheduler module 147.

Once a displayable portion of a calendar or schedule has been determined, a graphical user interface (e.g., a web page, etc.) including the displayable portion may be output for communication by the service provider computer 120 at the direction of the scheduler module 147. A client device 110 may receive the graphical user interface and present the displayable portion to the user. In one exemplary embodiment, the graphical user interface may be an interactive interface that facilitates the receipt of scroll and/or update requests.

With continued reference to the service provider computer 120, the one or more I/O interfaces 142 may facilitate communication between the service provider computer 120 and one or more input/output devices, for example, one or more user interface devices, such as a display, keypad, control panel, touch screen display, remote control, microphone, etc., that facilitate user interaction with the service provider computer 120. The one or more network interfaces 143 may facilitate connection of the service provider computer 120 to one or more suitable networks, for example, the networks 125, 130 illustrated in FIG. 1. In this regard, the service provider computer 120 may communicate with other components of the system 100.

With continued reference to FIG. 1, any number of client devices 110 may be provided. A client device 110 may be a suitable processor-driven device that facilitates communication with the service provider computers 120 in order to receive one or more graphical user interfaces associated with the patient scheduling services and/or EMR. Examples of suitable client devices 110 include, but are not limited to, a personal computer, a tablet computer, a mobile device (e.g., a mobile telephone, a personal digital assistant, etc.), one or more networked computers, an Internet appliance, an application-specific circuit, or any other processor-based device and/or other suitable device capable of network communication. In certain embodiments, a client device 110 may be associated with a healthcare provider (e.g., a physician, nurse practitioner, physician's office, hospital, clinic, physical therapist, a pharmacy, etc.). In other exemplary embodiments, a client device 110 may be associated with a patient. The execution of the computer-implemented instructions by the client device 110 may form a special-purpose computer or other particular machine operable to facilitate the request, receipt, processing, and/or presentation of patient scheduling services and/or EMRs. Additionally, in certain example embodiments, the operations and/or control of the client device 110 may be distributed among several processing components.

In addition to having one or more processors 160, the client device 110 may include one or more memory devices 161, one or more I/O interfaces 162, and/or one or more network interfaces 163. The memory devices 161 may be any suitable memory devices, for example, caches, read-only memory devices, random access memory devices, magnetic storage devices, removable storage devices, etc. The memory devices 161 may store data, executable instructions, and/or various program modules utilized by the client device 110, for example, data files 164, an OS 165, and/or a browser module 166 or client module. The data files 164 may include any suitable data that facilitates patient scheduling services and/or requests for EMR information, the receipt of information associated with EMRs, one or more graphical user interfaces associated with patient scheduling services and/or EMRs, and/or the presentation of received patient scheduling service information and/or EMR information. For example, the data files 164 may include, but are not limited to, information that facilitates communication with the service provider computers 120, login and/or authentication information that may be utilized to establish an authenticated communications session with the service provider computers 120, parameters and/or query information, received patient scheduling services information, and/or received information to be displayed (e.g., graphical user interface information, etc.).

The OS 165 may be a suitable software module that controls the general operation of the client device 110. The OS 165 may also facilitate the execution of other software modules by the one or more processors 160, for example, the browser module 166. The OS 165 may be any currently existing or future developed operating system including, but not limited to, Microsoft Windows®, Apple OSX™, Linux, Unix, or a mainframe operating system. The browser module 166 may be an Internet browser or other software, including a dedicated program or application, for interacting with the service provider computers 120. For example, a user, such as a doctor, nurse, nurse practitioner, physical therapist, pharmacist, hospital employee, or patient, may utilize the browser module 166 in preparing, providing or receiving information associated with patient scheduling services to or from the service provider computer 120.

The one or more I/O interfaces 162 may facilitate communication between the client device 110 and one or more input/output devices, for example, one or more user interface devices, such as a display, keypad, control panel, touch screen display, remote control, microphone, etc., that facilitate user interaction with the client device 110. The network interfaces 163 may facilitate connection of the client device 110 to one or more suitable networks, for example, the networks 125, 130. In this regard, the client device 110 may receive and/or communicate information to other network components of the system 100, such as the service provider computers 120.

With continued reference to FIG. 1, any number of data sources 115 may be provided as desired. A data source 115 may include any number of suitable processor-driven devices configured to store information associated with patient scheduling services and/or EMRs and to respond to requests for the stored information. For example, a data source 115 may include any number of special purpose computers or other particular machines, application-specific circuits, microcontrollers, personal computers, minicomputers, mainframe computers, servers, and the like. In certain embodiments, the operations of the data source 115 may be controlled by computer-executed or computer-implemented instructions that are executed by one or more processors associated with the data source 115 to form a special purpose computer or other particular machine.

Each data source 115 may include similar components to those described above for the service provider computers 120 and/or the client devices 110. For example, the data source 115 may include any number of processors, memory devices, I/O interfaces, and/or network interfaces. In certain embodiments, the data source 115 may include a suitable host module or other application that facilitates the receipt and/or processing of requests for data associated with patient scheduling services and/or EMRs.

The networks 125, 130 may include any number of telecommunication and/or data networks, whether public, private, or a combination thereof, including a local area network, a public switched telephone network, a wide area network, a cellular network, an intranet, the Internet, intermediate handheld data transfer devices, and/or any combination thereof and may be wired and/or wireless. In certain embodiments, one or more first networks 125, such as a wide area network, a cellular network, and/or the Internet, may facilitate communication between the client devices 110 and the service provider computers 120. Additionally, one or more second networks 130, such as a local area network or a wide area network, may facilitate communication between the service provider computers 120 and the data sources 115. In other embodiments, the first networks 125 and the second networks 130 may include common or shared networks.

Due to network connectivity, various methodologies as described herein may be practiced in the context of distributed computing environments. It is to be understood that any other network configuration is possible. For example, a network may include a plurality of networks, each with devices such as gateways and routers for providing connectivity between or among networks. Instead of or in addition to a network, dedicated communication links may be used to connect the various devices in accordance with an exemplary embodiment.

Those of ordinary skill in the art will appreciate that the system 100 shown in and described with respect to FIG. 1 is provided by way of example only. Numerous other operating environments, system architectures, and device configurations are possible. Other system embodiments can include fewer or greater numbers of components and may incorporate some or all of the functionality described with respect to the system components shown in FIG. 1.

Additionally, it will be appreciated that the scope and spirit of the embodiments disclosed herein are not limited to the offering, provision, and display of patient scheduling services and to the presentation of EMRs. Various embodiments may be utilized in conjunction with a wide variety of other types of data, including but not limited to, scheduling data, inventory data, and/or other types of data.

Operational Overview

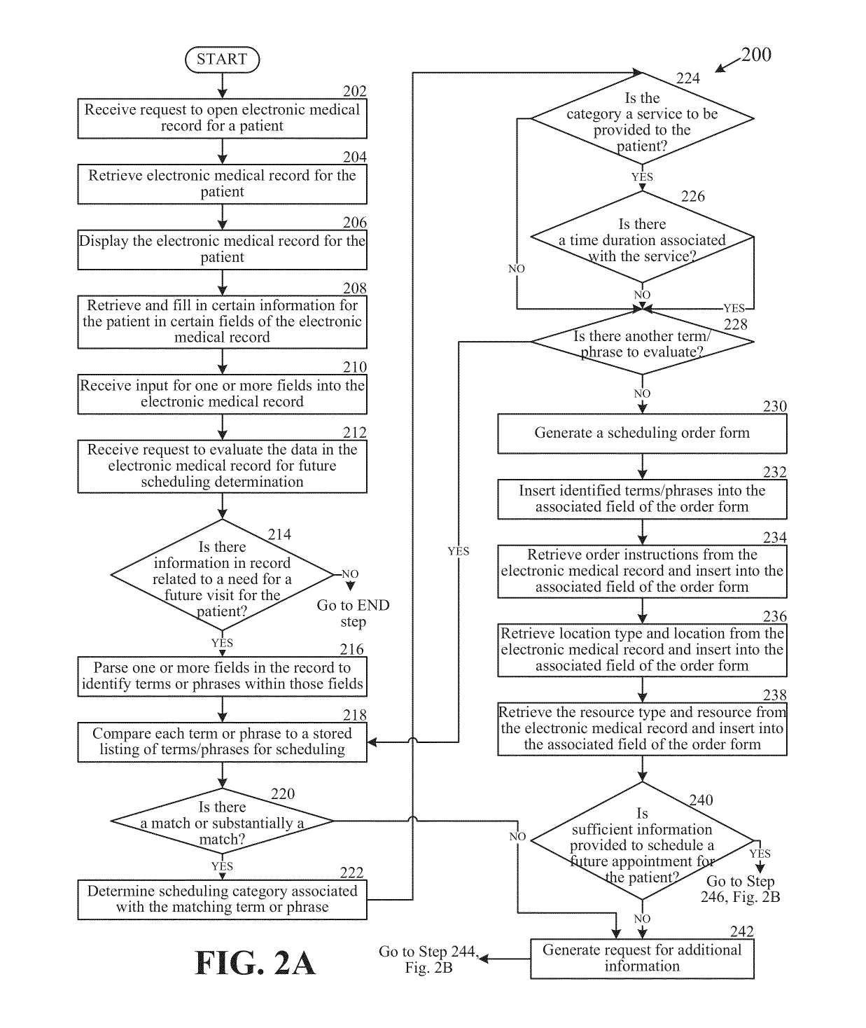

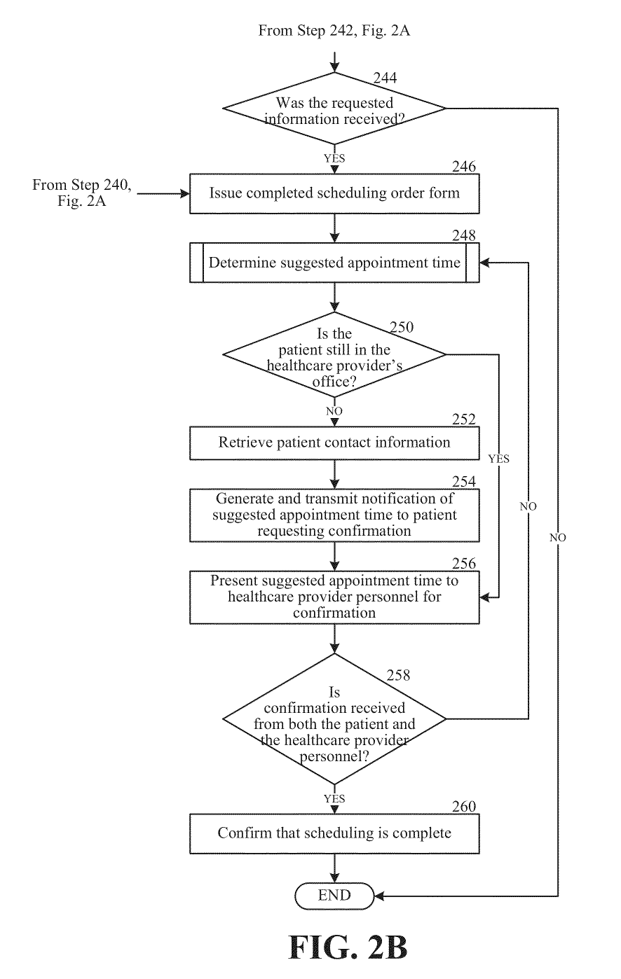

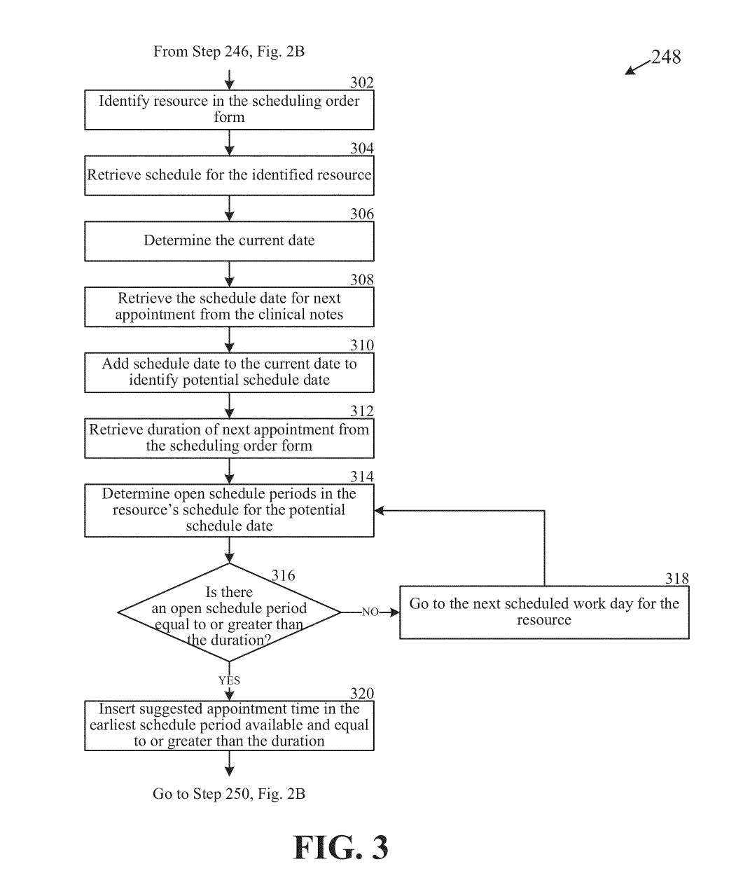

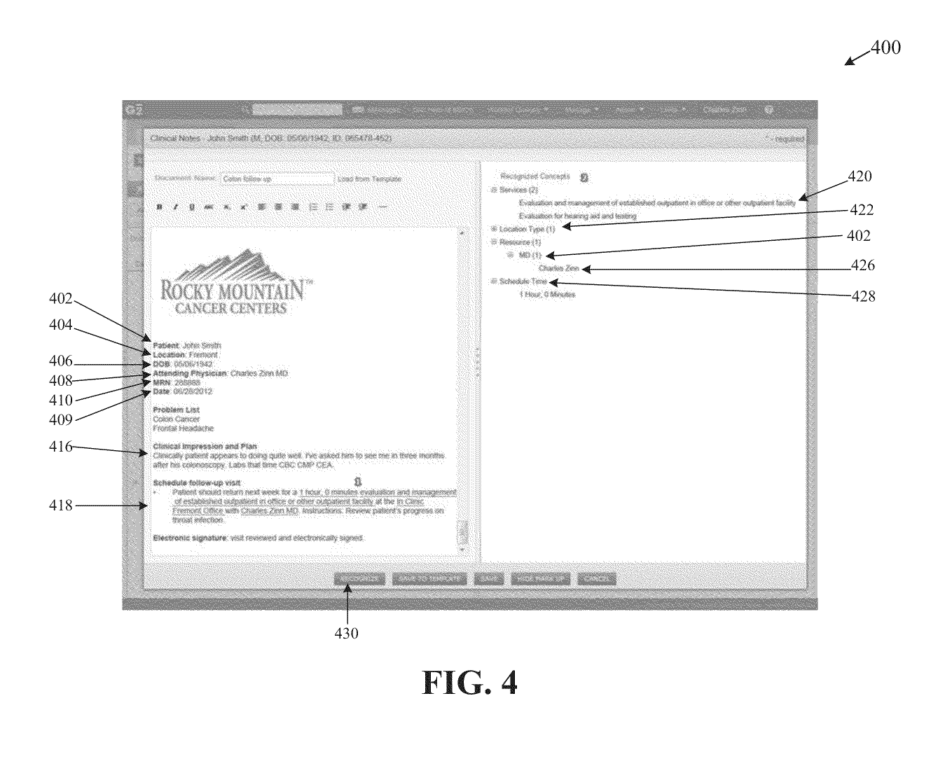

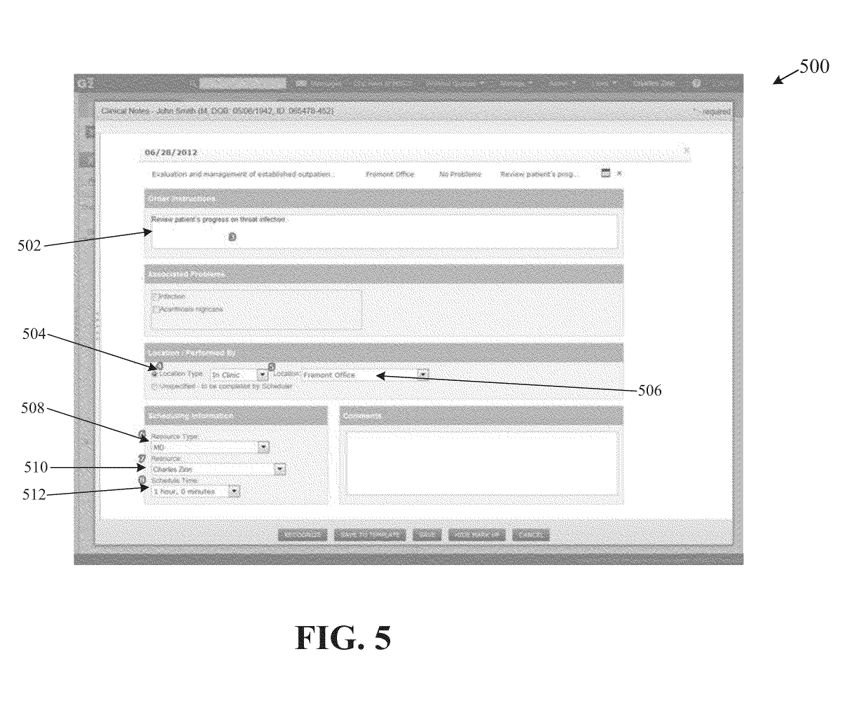

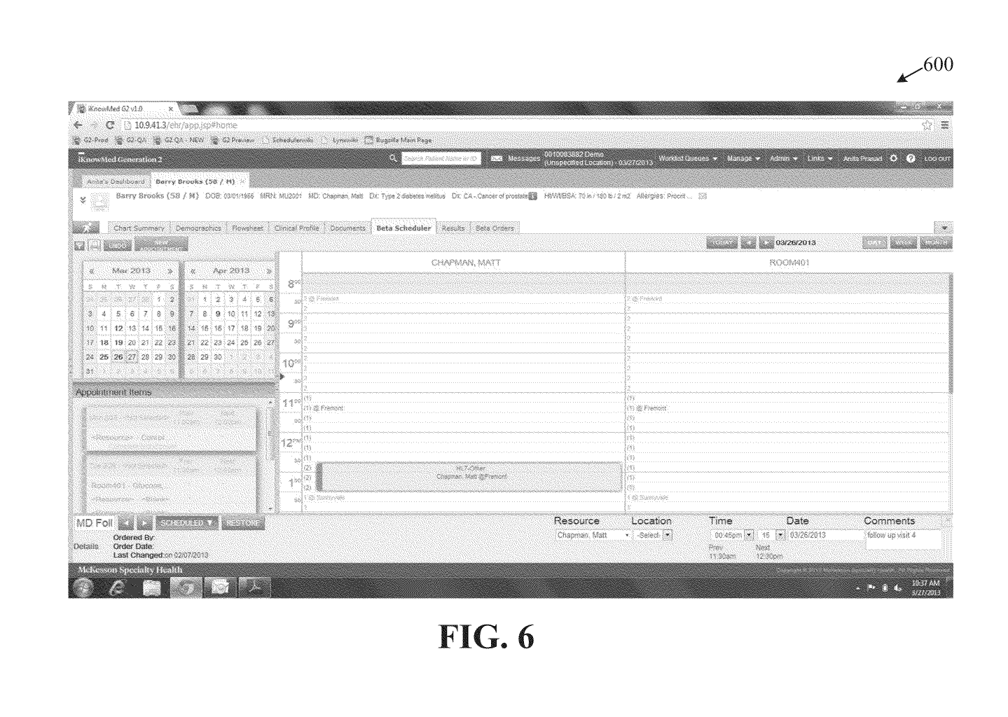

FIGS. 2A and 2B are a flow chart of an example method 200 for automatically scheduling patient visits based on information in clinical notes of EMRs, in accordance with one exemplary embodiment. FIG. 4 is a depiction of an example clinical notes page of an EMR that may be displayed on a client device 110, in accordance with on exemplary embodiment. FIG. 5 is a depiction of an example scheduling order form in the clinical notes for scheduling a patient visit that may be displayed on the client device 110, in accordance with one exemplary embodiment. FIG. 6 is a depiction of an example appointment scheduling page that may be displayed on a client device 110, in accordance with one exemplary embodiment. The exemplary method 200, described below, may be performed by a suitable service provider computer 120. Furthermore, the exemplary methods 200 and 248, described below, will be described with reference to a physician as the healthcare provider; however, this is only for purposes of example as other healthcare providers could be substituted for, and should each be individually read as being a part of each of these methods. As such, where the discussion of the methods 200 and 248 below and the drawings state a physician, any other healthcare provider could be substituted, such as a nurse, nurse practitioner, physical therapist, clinic, hospital, physician's office, pharmacist, healthcare center, or any other healthcare provider known to those of ordinary skill in the art.

Referring now to FIGS. 2A, 2B, and 4-6, the exemplary method 200 begins at the START step and proceeds to step 202, where a request is received at the service provider computer 120 from a client device 110 to open an EMR for a patient. In one exemplary embodiment, the request is made via browser module 166 through the network 125 to the host module 146. In step 204, the EMR for the patient is retrieved. In certain exemplary embodiments, the EMR and/or the information uploaded into the EMR is retrieved by the scheduler module 147 from the database 150 and/or data sources 115.

The EMR for the patient is displayed in step 206. For example, the EMR can be transmitted by the scheduler module 147 to the browser module 166 via the network for display on a graphical user interface of the client device 110. In step 208, certain information related to the patient is received and placed within certain fields of the EMR. In one exemplary embodiment, the information is received by the scheduler module 147 from the scheduling database 150, data sources 115 and/or other memory storage devices and inserted into the EMR. For example, as shown in the clinical notes page 400 of the EMR of FIG. 4, information can include, but is not limited to, the patient's name 402, the location of the services being provided 404, the patient's date of birth 406, the attending physician 408, the current date 409, and the medical record number (MRN) 410.

In step 210, inputs of information are received in one or more fields of the EMR. For example, the inputs can be made by the resource (in this case the attending physician) or an assistant of the resource and can be typed in or dictated into the fields presented by the browser module 166 through the I/O interface 162. In one exemplary embodiment, the inputs can be information in a clinical impressions and plan field 416, a schedule visit field 418, a services field 420, a location type field 422, a resource type field 424, a resource field 426, and a time duration field 428. In alternative embodiments, the location type field 422, resource type field 424, and resource field 426 are automatically populated by, for example, the scheduler module 147 based on the location 404 and the attending physician 406 information. In step 212, a request is received to evaluate the data in the clinical notes page 400 for purposes of providing patient scheduling services. For example, the request is generated by the user selecting the recognize radio button 430. Alternatively many other options may be provided for the user to initiate the evaluation of the data. In yet another alternative embodiment, the scheduler module 146 can automatically initial the evaluation of the data in the clinical notes page 400.

In step 214 an inquiry is conducted to determine if there is information in the clinical notes page 400 that indicates a need for a future visit for the patient. In certain exemplary embodiments, the determination is made by the scheduler module 147. For example, the scheduler module 147 can evaluate if any inputs were made to the schedule visit field 418. In alternative embodiments, the scheduler module 147 can evaluate information throughout other portions of the clinical notes page 400 or other portions of the EMR to make the determination in a manner similar to the matching that will be described below in step 218. If there is no information in the clinical notes page 400 or EMR that indicate a need for a future visit for the patient, the NO branch is followed to the END step. Otherwise, the YES branch is followed to step 216.

In step 216, one or more fields of the EMR are parsed to identify terms or phrases within those fields. In one exemplary embodiment, the fields of the clinical notes page 400 are parsed by the scheduler module 147 or some other module of the service provider computer 120. For example, the scheduler module 147 can parse the information in the schedule visit field 418. In addition or alternatively, other fields of the clinical notes page 400 may be parsed to identify terms and phrases therein. In step 218, each term and/or phrase is compared to a stored listing of terms and phrases. For example, the scheduler module 147 can retrieve/receive terms and phrases from the scheduling database 150. The terms and phrases, as well as any plural and/or singular versions of the terms and phrases and/or synonyms or typical grammatical spelling error versions of the terms and phrases can be compared by the scheduler module 147 to the terms and/or phrases identified in the schedule visit field 418 as well as other fields in the clinical notes page 400.

In step 220, an inquiry is conducted to determine if a match or substantial match was identified? For example, the terms and phrases identified in step 216 are compared to the stored terms and phrases. For certain stored terms and phrases, synonyms or typical misspellings or grammatical variations (including errors) may also be provided, such as in the database 150, and can also be compared to the terms and phrases identified in step 216. Further, the schedule module 147 may be capable of identifying plural or singular versions of stored terms and phrases in the terms and phrases identified in step 216. In an alternative embodiment, the matching mechanism is reversed and the scheduler module 147 can retrieve, such as in a one-by-one fashion, the stored terms and phrases (as well as plural, singular, synonyms, typical misspellings, and grammatical variations) and compare them to the terms and phrases identified in one or more parsed or unparsed fields of the EMR (e.g., the clinical notes page 400) in step 216. In one exemplary embodiment, the determination is made by the scheduler module 147. If there is no match or substantial match, the NO branch is followed to step 242, discussed below. If a match or substantial match is identified, the YES branch is followed to step 222.

In step 222, the scheduling category associated with the matched term or phrase is determined. In one exemplary embodiment, the determination is made by the scheduler module 147. For example, each stored term or phrase in the database 150 may include one or more scheduling categories associated therewith. As such, when a match to a stored term or phrase is identified, the scheduler module 147 can check the database 150 to determine the scheduling category associated with the matched stored term or phrase. In one exemplary embodiment, the scheduling categories include, but are not limited to, location type, location, resource type, resource, time duration for the next visit, service to be provided to the patient (service), schedule date, and order instructions. For example, the location type and location identify where the next visit will take place (e.g., physician's office, lab, physical therapist's office, hospital, etc.). In certain exemplary embodiments, the resource type and resource identify who will be conducting the evaluation of the patient. For example, the resource type can include, but is not limited to, a registered nurse, nurse practitioner, physical therapist, physician, lab technician, etc.) and the resource is the specific person within that resource type that will conduct the evaluation. For example, in the clinical notes 400, the resource type 424 is a medical doctor (MD) and the resource 426 is Charles Zinn. In one exemplary embodiment, the time of duration for the next visit is an estimation of the amount of time the resource may need to be with the patient and/or the amount of time the patient will be receiving the service during the next visit. In certain embodiments, the time of duration is identified in the database 150 in association with a term or phrase categorized as a service for the patient. In one exemplary embodiment, the service for the patient is basis for the next visit, such as the lab test, evaluation, therapy, check-up, or other care that the patient will be receiving during the next visit. In one exemplary embodiment, the schedule date is the date in the future that the patient should have the next visit. This date may be a date certain or a general time in the future (e.g., represented by an identification of the number of days, weeks or months in the future to schedule the visit). The order instructions, like the service may provide information regarding what will occur with respect to the patient during the next visit.

In step 224, an inquiry is conducted to determine if the scheduling category associated with the matched term/phrase is a service for the patient. In certain exemplary embodiments, the determination is made by the scheduler module 147 based on an evaluation of the matched stored term/phrase in the database 150. The determination may be made because, for certain services, a time duration may be associated with the service in the database 150 or in other memory devices. If the category for the matched term/phrase is a service, then the YES branch is followed to step 226. Otherwise, the NO branch is followed to step 228.

In step 226, an inquiry is conducted to determine if there is a time duration associated with the service. In one exemplary embodiment, the time duration may be provided in and similarly associated with the matched stored term/phrase in the database 150 or another memory storage device. Alternatively, the database 150 or another memory storage device communicably coupled to the service provider computer 120 may include a separate table, listing, or schedule of services and the time duration of each service. If there is a time duration associated with the service, the time duration is noted and stored for comparison to any other information associated with the time duration category in the parsed and matched terms/phrases from the EMR. For example, if no other information is identified as a match from the EMR that has a scheduling category association of time duration, then the time duration associated with the service may be used. Alternatively, if other information is identified as a match from the EMR that falls under the time duration scheduling category then based on a preset, adjustable priority, either the time duration associated with the service or the time duration identified in the EMR may be used for purposes of scheduling the next visit. In there is a time duration associated with the service identified as a match, the YES branch is followed to step 228. Similarly, if there is no time duration associated with the service identified as a match, the NO branch is followed to step 228.

In step 228 an inquiry is conducted to determine if there is another term and/or phrase to evaluate. For example, the scheduler module 147 may evaluate the parsed information from the EMR (e.g., the clinical notes page) to determine if another term or phrase needs to be checked for a potential match. Alternatively, if the matching is driven by going through the stored terms/phrases stored in the database 150 or other memory storage device and then comparing each to terms/phrases in the EMR the determination can be made by the scheduler module 147 as whether another stored term/phrase in the database 150 needs to be evaluated for a possible match to a term/phrase in the EMR. If another term and/or phrase needs to be evaluated, the YES branch is followed to step 218 to conduct the matching comparison. If no additions terms and/or phrases need to be evaluated, then the NO branch is followed to step 230.

In step 230, a scheduling order form is generated. In one exemplary embodiment, the scheduling order form is generated by the scheduler module 147 and displayed at the client device 110 by the browser module 166 via the network 125. FIG. 5 illustrates an example depiction of the scheduling order form 500. In step 232, the identified terms and/or phrases are inserted into their associated fields on the order form 500. For example, the scheduling order form 500 can include a service field 502 for receiving information associated with the service scheduling category, a location type field 504 for receiving information associated with the location type scheduling category, a location field 506 for receiving information associated with the location scheduling category, a resource type field 508 for receiving information associated with the resource type scheduling category, a resource field 510 for receiving information associated with the resource scheduling category, and a time duration field 512 for receiving information associated with the time duration scheduling category. Each field can be capable of receiving information related to its associated scheduling category discussed above. For example, the scheduler module can retrieve information for each scheduling category identified from the clinical notes page 400 and insert it into the proper field of the scheduling order form 500.

In step 234, in not already completed, the order instructions or service to be provided to the patient are retrieved from the clinical notes page 400 of the EMR and inserted into the service field 502 of the scheduling order form. In one exemplary embodiment, the information is retrieved and inserted by the scheduler module 147 from terms and/or phrases parsed from the schedule visit field 418 and or the service field 420 of the clinical notes page 400. The location type and location information are retrieved (e.g., by the scheduler module 147) from the EMR (e.g., clinical notes page 500) and inserted, if not already done so, into the associated fields 504, 506 of the scheduling order form 500 in step 236. In step 238, resource type and resource information are retrieved (e.g., by the scheduler module 147) from the EMR (e.g., clinical notes page 500) and inserted, if not already done so, into the associated fields 508, 510 of the scheduling order form 500.

In step 240, an inquiry is conducted to determine if there has been provided and/or obtained/retrieved to schedule a future appointment for the patient. In one exemplary embodiment, the determination is made by the scheduler module 147. For example, one or more combinations of the following fields may be needed to properly and automatically schedule a subsequent visit for the patient: patient name, resource type, resource, location type, location, service, time duration, and schedule date. In one example, the patient name, time duration, and schedule date are needed to schedule a subsequent visit. In another example, patient name, resource, time duration, and schedule date are needed to schedule a subsequent visit. In yet another non-limiting example, the patient name, resource, location, service, time duration and schedule date are needed to schedule a subsequent visit. As can be seen from the above, a variety of mixes of information may be desired based on the particular needs or the developer for determining what information is needed to schedule a subsequent visit by the patient. If there is sufficient information provided to schedule a future appointment, the YES branch is followed to step 246. On the other hand, if there is not sufficient information provided to schedule a future appointment for the patient, the NO branch is followed to step 242, where the schedule module 147 can determine what additional information in one or more scheduling categories is needed and can generate and transmit a request for that information. For example, the scheduler module 147 can transmit the request via the network 125 to the client device 110 for display to a healthcare provider or their assistant via the browser module 166.

In step 244, an inquiry is conducted to determine if the requested additional information was received in response to the request made in step 242. For example, a response can be received via an input made at the client device 110 (e.g., by a healthcare provider or other user using the I/O interface 162 and the browser module 166) and can be identified or received by the scheduler module 147 by way of the network 125. If the additional requested information is not received, the NO branch is followed to the END step or alternatively back to step 242 to again request the information. Otherwise, the YES branch is followed to step 246.

In step 246, a completed scheduling order form is issued or provided to the scheduler module for determination of a suggested appointment time for the next visit of the patient. In step 248, the suggested appointment time for the next visit of the patient is determined. In one example, the suggested appointment time is determined by the scheduler module 147 based on the information in the scheduling order form and/or the clinical notes of the EMR. Additional information related to determining the suggested appointment time will be discussed with regard to FIG. 3 below.

In step 250, a determination is optionally made as to whether the patient is still in the healthcare provider's office or place where they are currently receiving treatment. In alternative embodiments, this determination may not be made and confirmation of the suggested appointment time with the patient may or may not be undertaken. If the patient is still in the office or location of current treatment, the YES branch is followed to step 256 to conduct a confirmation of the suggested appointment time with the patient in a face-to-face manner. If the patient is not in the healthcare provider's office or location of current treatment, the NO branch is followed to step 252, where the patient contact information is received. In one exemplary embodiment, the scheduler module 147 can obtain the patient contact information from the database 150, other data sources 115 and/or other memory storage devices. Examples of the patient contact information include, but are not limited to, an email address and a phone number.

A notification is generated and transmitted to the patient based on the received contact information, providing the suggested appointment time and requesting confirmation from the patient that the suggested appointment time is acceptable to the patient in step 254. In one exemplary embodiment, the scheduler module 147 generates an email or meeting/appointment request and sends the email or meeting/appointment request to the patient via the received patient email address. In another exemplary embodiment, the scheduler module 147 in cooperation with an automated IVR system (not shown) initiates an automated call with the patient at the received patient telephone number and provides information regarding the suggested appointment time and can further request confirmation that the suggested time is acceptable. In yet another alternative embodiment, the scheduler module 147 can generate a notification to the healthcare provider or an employee or assistant of the healthcare provider (e.g., the scheduler) to contact the patient regarding the suggested appointment time and the scheduler can contact the patient via email or telephone.

In step 256, the suggested appointment time is presented to the resource (e.g., healthcare provider) identified in the scheduling order form or an employee or assistant of the resource (e.g., the scheduler) to confirm that the automatically determined time is acceptable to the resource. For example, the scheduler module 147 can generate a depiction of a calendar or appointment scheduling page, such as the appointment scheduling page 600 of FIG. 6 and provider a confirmation mechanism, such as one or more radio buttons on or adjacent to the page 600 to receive an input from the resource or their assistant confirming whether the suggested appointment time is acceptable. Alternatively, the determination may be made whether the time is acceptable to the resource before communicating with the patient to receive confirmation or vice-versa.

In step 258, an inquiry is conducted to determine if the patient and the resource have both confirmed that the suggested appointment time is acceptable. In one exemplary embodiment, the determination can be made by the scheduler module 147. If at least one of the parties has provided information that the suggested appointment time is not acceptable (e.g., by rejecting the suggested appointment time via email, IVR, voice mail, in person, or via response to the appointment scheduling page 600, then the NO branch is followed back to step 248 to identify the next suggested appointment time given the parameters in the scheduling order form 500, clinical notes page 400, other portions of the EMR, and/or the current schedule for the resource. If, however, the resource and the patient confirm that the time is acceptable, the YES branch is followed to step 260, where a confirmation can be made that the scheduling of the next appointment time for the patient is complete. For example, the scheduler module 147 or another portion of the service provider computer 120 or the client device 110 can insert the appointment into the schedule of the resource. Further, the scheduler module can generate or have generated correspondence to the patient and/or the resource providing the confirmed appointment time. The correspondence can be via email, text, IVR, or traditional mail. The process then continues to the END step.

FIG. 3 is a flow chart of an example method 248 for automatically determining a suggested appointment time for a patient visit according to one exemplary embodiment. Referring now to FIGS. 1-6, the exemplary method 248 begins at step 302, where the resource that needs to be scheduled is identified. For example, the scheduler module 147 can determine the resource from information in the scheduling order form 500 (e.g., the resource field 510), the clinical notes 400 (e.g., the resource field 426), and/or another portion of the EMR for the patient. In step 304, the schedule for the identified resource is received. In one exemplary embodiment, the scheduler module 147 can obtain the schedule/calendar or a copy thereof for the particular resource from the database 150, from a memory storage device (e.g., data files 164) at the client device 110, the data files 144 of the service provider computer 120, or from other data sources 115 via the network 130. In one example embodiment, the schedule/calendar may be the same as or similar to the depiction of the exemplary scheduling page 600 of FIG. 6.

The current date is determined in step 306. In one exemplary embodiment, the scheduler module 147 determines the current date or another date and uses that as the basis for calculated or otherwise determining potential suggested appointment time. In step 308, the scheduler module 147 can retrieve the schedule date for the next visit for the patient. In certain exemplary embodiments, the schedule date can be retrieved from the scheduling order form, the clinical notes page 400 (e.g., from the schedule visit field 418) or another portion of the EMR. As discussed above, the schedule date can be a date certain (e.g., tomorrow, Mar. 15, 2013, March 15^{th}, next Monday, etc.). In those situations, it may not be necessary to determine the current date as the date certain provided in the schedule date will be the starting point for attempting to identify a suggested appointment time. Alternative, as discussed above, the schedule date can be a general time frame (e.g., one week, two weeks, one month, three days, etc.). In step 310, the scheduler module 147 can add the schedule date to the current date to identify a potential schedule date. For example, if the current date is Mar. 13, 2013, and the schedule date was “two weeks”, then the schedule module 147 could add fourteen days to the current date to come up with the potential schedule date of Mar. 27, 2013. Similarly, if the schedule date was “next month” or “one month,” the scheduler module 147 can add one month to the current date of Mar. 13, 2013 to come up with the potential schedule date of Apr. 13, 2013.

In step 312, the scheduler module 147 can receive the time duration for the next appointment for the patient. In certain exemplary embodiments, the time duration can be obtained by the scheduler module 147 from the time duration field 428 of the clinical notes page 400, the time duration field 512 of the scheduling order form 500 or another portion of the EMR. The open schedule periods in the resource's schedule for the potential schedule date are determined in step 314. In one exemplary embodiment, the determination is made by the schedule module 147 based on an evaluation of the schedule/calendar (e.g., the scheduling page 600) for the resource. For example, if the resource has schedule openings from 9:30-10:00; 1:00-2:00; 2:30-3:00; and 3:30-5:00, then each would be considered an open schedule period.

In step 316, an inquiry is conducted to determine if there is an open schedule period for the resource that is equal to or greater than the time duration. In certain exemplary embodiments, the determination can be made by the scheduler module 147 based on an evaluation of the schedule/calendar (e.g., the scheduling page 600) for the resource. Using the example above, For example, if time duration is one hour and the resource has open schedule periods from 9:30-10:00; 1:00-2:00; 2:30-3:00; and 3:30-5:00, then the periods 1:00-2:00 and 3:30-5:00 would be equal to or greater than the time duration and would be times available for proposing an appointment for the patient. In certain exemplary embodiments, preferences may be added for scheduling appoints earlier in the day or later in the day. Also, preferences may be added for scheduling certain services for certain times of the day (e.g., certain lab tests for early in the morning due to food/beverage intake limitations).

If there is not an open schedule period that is equal to or greater than the time duration, then the NO branch is followed to step 318, where the scheduler module 147 can go to the next scheduled work day for the resource. The process then returns to step 314 to determine open schedule periods and then determine if any of those periods are equal to or greater than the time duration for the appointment with the patient. While the example of step 318 discusses going forward in the calendar schedule for the resource, alternatively, in certain exemplary embodiments, the scheduler module 147 could identify prior scheduled work days for the resource instead and then proceed back to step 314. Returning to step 316, if there is an open schedule period on the potential schedule date that is equal to or greater than the time duration, then the YES branch is followed to step 320, where the scheduler module 147 can insert the suggested appointment time in one of the open schedule periods that qualify. For example, the scheduler module can insert the suggested appointment time in the earliest or latest open schedule period or the earliest or latest portion of an open schedule period based on the preferences of the scheduler and/or the user. The process then proceeds to step 250 of FIG. 2B.

The methods described and shown in FIGS. 2A-3 may be carried out or performed in any suitable order as desired in various embodiments. Additionally, in certain exemplary embodiments, at least a portion of the operations may be carried out in parallel. Furthermore, in certain exemplary embodiments, less than or more than the operations described in FIGS. 2A-3 may be performed.

Accordingly, example embodiments disclosed herein can provide the technical effects of creating a system and methods that provides a real-time or near real time automated scheduling of patient visits to healthcare providers based on information obtained from an EMR, such as from the clinical notes portion of an EMR provided during or immediately after a patient visit. In this regard, healthcare providers can more quickly, easily and efficiently schedule patient visits.

Various block and/or flow diagrams of systems and methods and/or computer program products according to example embodiments are described above. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments.

These computer-executable program instructions may be loaded onto a special purpose computer or other particular machine, a processor, or other programmable data processing apparatus to produce a particular machine, such that the instructions that execute on the computer, processor, or other programmable data processing apparatus create means for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments, such as those disclosed herein, may provide for a computer program product that includes a computer usable medium having a computer-readable program code or program instructions embodied therein, said computer-readable program code adapted to be executed to implement one or more functions specified in the flow diagram step or steps. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram step or steps.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

Many modifications and other embodiments of those set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A computer-implemented method, comprising:
evaluating, by a service provider computer, an electronic medical record for a patient to determine if it contains information indicating a need to schedule a future visit with the patient;
identifying, by the service provider computer, a plurality of scheduling parameters from the electronic medical record;
receiving, by the service provider computer, a schedule for a healthcare provider;
evaluating, by the service provider computer, the schedule of the healthcare provider based on one or more of the plurality of scheduling parameters; and
identifying, by the service provider computer, a suggested appointment time for the future visit for the patient based at least in part on the evaluation of the schedule.

2. The computer-implemented method of claim 1, wherein evaluating the electronic medical record for the patient comprises the steps of:
identifying, by the service provider computer, a clinical notes section of the electronic medical records for the patient;
identifying, by the service provider computer, a schedule visit field of the clinical notes section; and
determining, by the service provider computer, if scheduling data is in the schedule visit field of the clinical notes section.

3. The computer-implemented method of claim 1, wherein identifying the plurality of scheduling parameters from the electronic medical record comprises the steps of:
parsing, by the service provider computer, at least one field of the electronic medical record to identify one or more terms within the respective field;
comparing, by the service provider computer, each identified term to a schedule comprising a plurality of terms associated with scheduling parameters; and
determining, by the service provider computer, if there is at least a substantial match between the identified term and at least one of the plurality of terms in the schedule;
wherein the identified term is identified as at least one scheduling parameter based on the positive determination that that there is a substantial match between the identified term and at least one of the plurality of terms in the schedule.

4. The computer-implemented method of claim 3, wherein identifying the plurality of scheduling parameters from the electronic medical record further comprises the steps of:
determining, by the service provider computer, one of a plurality of scheduling categories associated with each respective identified scheduling parameter; and
determining, by the service provider computer, if sufficient scheduling parameters have been identified to determine the suggested appointment time.

5. The computer-implemented method of claim 4, further comprising the steps of:
generating, by the service provider computer, a request for additional scheduling parameters based on a negative determination that the sufficient scheduling parameters have been identified to determine the suggested appointment time; and
transmitting, by the service provider computer, the request to a client device associated with the healthcare provider.

6. The computer-implemented method of claim 3, wherein identifying the plurality of scheduling parameters from the electronic medical record further comprises the steps of:
identifying, by the service provider computer, one or more fields in the electronic medical record associated with at least one scheduling parameter;
determining, by the service provider computer, if each of the one or more fields comprises input data; and
identifying, by the service provider computer, the input data in the respective field as at least one scheduling parameter.

7. The computer-implemented method of claim 1, wherein evaluating the schedule of the healthcare provider based on one or more of the plurality of scheduling parameters comprises:
receiving, by the service provider computer, a current date;
receiving, by the service provider computer, a schedule date scheduling parameter from the identified plurality of scheduling parameters;
determining, by the service provider computer, a potential schedule date based at least in part on the current date and the schedule date;
receiving, by the service provider computer, a time duration scheduling parameter from the identified plurality of scheduling parameters;
evaluating, by the service provider computer, the potential schedule date on the schedule for the healthcare provider to determine if one or more open schedule periods exist;
comparing, by the service provider computer, the time duration scheduling parameter to each open schedule period based on a positive determination that at least one open schedule period exists for the potential schedule date on the schedule for the healthcare provider; and
determining, by the service provider computer, if at least one of the one or more open schedule periods is greater than or equal to the time duration scheduling parameter.

8. The computer-implemented method of claim 7, wherein identifying the suggested appointment time for the future visit for the patient comprises the step of identifying, by the service provider computer, the suggested appointment time for the potential schedule date based on a positive determination that at least one of the one or more open schedule periods is greater than or equal to the time duration scheduling parameter.

9. The computer-implemented method of claim 7, further comprising the steps of:
identifying, by the service provider computer, a second potential schedule date on the schedule for the healthcare provider based on a negative determination that at least one of the one or more open schedule periods is greater than or equal to the time duration scheduling parameter, wherein the second potential schedule date is one of a next work day or a prior work day on the schedule for the healthcare provider;
determining, by the service provider computer, if one or more open schedule periods exist for the healthcare provider on the second potential schedule date;
comparing, by the service provider computer, the time duration scheduling parameter to each open schedule period on the second potential schedule date, based on a positive determination that at least one open schedule period exists for the second potential schedule date; and
determining, by the service provider computer, if at least one of the one or more open schedule periods for the second potential schedule date is greater than or equal to the time duration scheduling parameter.

10. The computer-implemented method of claim 1, wherein receiving the schedule for the healthcare provider comprises the steps of:
identifying, by the service provider computer, in a clinical notes section of the electronic medical record an indication of the healthcare provider to meet with the patient during the future visit with the patient; and
retrieving, by the service provider computer, the schedule for the identified healthcare provider, wherein the schedule comprises an appointment schedule including a plurality of times and dates and identifying for the healthcare provider a plurality of appointments with a plurality of patients within the plurality of times and dates.

11. A system, comprising;
at least one memory operable to store computer-executable instructions; and
at least one processor configured to access the at least one memory and execute the computer-executable instructions to:
evaluate an electronic medical record for a patient to determine if it contains information indicating a need to schedule a future visit with the patient;
identify a plurality of scheduling parameters from the electronic medical record;
receive a schedule for a healthcare provider;
evaluate the schedule of the healthcare provider based on one or more of the plurality of scheduling parameters; and
identify a suggested appointment time for the future visit for the patient based at least in part on the evaluation of the schedule.

12. The system of claim 11, wherein the at least one processor is further configured to evaluate the electronic medical record for the patient by accessing the at least one memory and execute the computer-executable instructions to:
identify a clinical notes section of the electronic medical records for the patient;
identify a schedule visit field of the clinical notes section; and
determine if scheduling data is in the schedule visit field of the clinical notes section.

13. The system of claim 11, wherein the at least one processor is configured to identify the plurality of scheduling parameters from the electronic medical record by accessing the at least one memory and execute the computer-executable instructions to:
parse at least one field of the electronic medical record to identify one or more terms within the respective field;
compare each identified term to a schedule comprising a plurality of terms associated with scheduling parameters; and
determine if there is at least a substantial match between the identified term and at least one of the plurality of terms in the schedule;
wherein the identified term is identified as at least one scheduling parameter based on the positive determination that that there is a substantial match between the identified term and at least one of the plurality of terms in the schedule.

14. The system of claim 13, wherein the at least one processor is further configured to identify the plurality of scheduling parameters from the electronic medical record by accessing the at least one memory and execute the computer-executable instructions to:
determine one of a plurality of scheduling categories associated with each respective identified scheduling parameter; and
determine if sufficient scheduling parameters have been identified to determine the suggested appointment time.

15. The system of claim 14, wherein the at least one processor is further configured to access the at least one memory and execute the computer-executable instructions to:
generate a request for additional scheduling parameters based on a negative determination that the sufficient scheduling parameters have been identified to determine the suggested appointment time; and
direct the communication of the request to a client device associated with the healthcare provider.

16. The system of claim 13, wherein the at least one processor is further configured to identify the plurality of scheduling parameters from the electronic medical record by accessing the at least one memory and execute the computer-executable instructions to:
identify one or more fields in the electronic medical record associated with at least one scheduling parameter;
determine if each of the one or more fields comprises input data; and
identify the input data in the respective field as at least one scheduling parameter.

17. The system of claim 11, wherein the at least one processor is configured to evaluate the schedule of the healthcare provider based on one or more of the plurality of scheduling parameters by accessing the at least one memory and execute the computer-executable instructions to:
receive a current date;
receive a schedule date scheduling parameter from the identified plurality of scheduling parameters;
determine a potential schedule date based at least in part on the current date and the schedule date;
receive a time duration scheduling parameter from the identified plurality of scheduling parameters;
evaluate the potential schedule date on the schedule for the healthcare provider to determine if one or more open schedule periods exist;
compare the time duration scheduling parameter to each open schedule period based on a positive determination that at least one open schedule period exists for the potential schedule date on the schedule for the healthcare provider; and
determine if at least one of the one or more open schedule periods is greater than or equal to the time duration scheduling parameter.

18. The system of claim 17, wherein the at least one processor is configured to identify the suggested appointment time for the future visit for the patient by accessing the at least one memory and execute the computer-executable instructions to:
identify the suggested appointment time for the potential schedule date based on a positive determination that at least one of the one or more open schedule periods is greater than or equal to the time duration scheduling parameter.

19. The system of claim 17, wherein the at least one processor is further configured to access the at least one memory and execute the computer-executable instructions to:
identify a second potential schedule date on the schedule for the healthcare provider based on a negative determination that at least one of the one or more open schedule periods is greater than or equal to the time duration scheduling parameter, wherein the second potential schedule date is one of a next work day or a prior work day on the schedule for the healthcare provider;
determine if one or more open schedule periods exist for the healthcare provider on the second potential schedule date;
compare the time duration scheduling parameter to each open schedule period on the second potential schedule date, based on a positive determination that at least one open schedule period exists for the second potential schedule date; and
determine if at least one of the one or more open schedule periods for the second potential schedule date is greater than or equal to the time duration scheduling parameter.

20. The system of claim 11, wherein the at least one processor is further configured to receive the schedule for the healthcare provider by accessing the at least one memory and execute the computer-executable instructions to:
identify in a clinical notes section of the electronic medical record an indication of the healthcare provider to meet with the patient during the future visit with the patient; and
retrieve the schedule for the identified healthcare provider, wherein the schedule comprises an appointment schedule including a plurality of times and dates and identifying for the healthcare provider a plurality of appointments with a plurality of patients within the plurality of times and dates.
